(19) United States
(12) Patent Application Publication
(10) Pub. No.: US 2026/0121777 A1
(43) Pub. Date: Apr. 30, 2026

(54) METHOD FOR SYNCHRONIZING INTELLIGENT ELECTRONIC UNITS IN A LOCALLY RESTRICTED NETWORK

(71) Applicant: Siemens Aktiengesellschaft, München (DE)

(72) Inventors: Jörg Weilbier, Berlin (DE); Stefan Flemming, Erlangen (DE); Andrej Görbing, Berlin (DE); Ji Chen, Nanjing (CN); Yi Pan, Nanjing (CN)

(21) Appl. No.: 19/472,811

(22) PCT Filed: Mar. 28, 2024
(86) PCT No.: PCT/EP2024/058500

§ 371 Date: Oct. 6, 2025

(30) Foreign Application Priority Data
Apr. 5, 2023 (EP) 23166818.7

(51) Int. Cl. H04J 3/06

(52) U.S. Cl. CPC H04J 3/0641; H04J 3/0667

(57) ABSTRACT

A method for synchronizing intelligent electronic units IEDs in a locally restricted network, which has at least two timing units. For a timing unit that has become functional again or has been reconnected to the network, checking whether the network contains a further timing unit in an active grandmaster role. Forcing the first timing unit into its slave state when another timing unit in the grandmaster role has been detected in the locally restricted network, wherein the first timing unit synchronizes with the timing unit in the grandmaster role. Once synchronization is complete, no longer forcing the first timing unit into the slave state. The first timing unit switches to the role of grandmaster timing unit when it is better suited to the grandmaster role, or it remains in its slave state when another timing unit in the network is better suited to the grandmaster role.

In order to synchronize the timing of devices that are connected to one another via a network, a Network Time Protocol was created, which is abbreviated to NTP below. Furthermore, the time protocol called the Precision Time Protocol and referred to as the PTP below has been introduced. In comparison with the NTP, the PTP has higher accuracy when recording the time of the devices that are connected to one another via a network.

For example, a locally restricted network is implemented in electrical power supply substations. Such substations are used to lower or raise the network voltages prevailing in the supply network by means of a transformer whose mode of operation is known. In addition to a transformer, substations have switching units such as circuit breakers that, after receiving a switching signal, disconnect conductor outgoers of the substation from the rest of the supply network.

Said switching signals are generated by protection and automation devices that are used to monitor the current and voltage characteristics in the conductors of the substation for the presence of fault conditions. If there is a fault condition, a switching signal is generated and transmitted to one or more selected switching units so that the switching units are moved to their interrupter position. In the interrupter position, the contacts of the selected switching units are separated from one another, preventing a flow of current via the switching units. A conductor run connected to one contact of said switching unit is then disconnected from the rest of the supply network, which is connected to the other contact of said switching unit.

In order for the protection and automation devices to be able to monitor the current and voltage characteristics in the conductors of the substation for the presence of fault conditions, they must be continuously supplied with time-dependent current and voltage values. In order to provide these current and voltage values, there is provision for current and voltage transformers that record current and voltage in the conductors at a measuring point of the substation and provide a calibrated measurement signal on the secondary side, which signal is sampled at a specified sampling rate to obtain samples. The samples are then digitized. In addition, a time stamp is permanently assigned to the samples. This is done by means of so-called “merging units” or using other intelligent electronic devices (IEDs) in the substation. In order to be able to compare the measured values with one another, the time recording of the IEDs connected to one another via a process bus must be synchronized. This is accomplished using said PTP.

The PTP is thus used in digital electrical power supply substations to synchronize intelligent electronic devices (IEDs), for example in the so-called IEC 61850 process bus.

The comparability of the measured values originating from different IEDs is critical. Lost or insufficient time synchronization between these devices leads to the protection functions in the protection and automation devices being disabled or to a switching unit being erroneously tripped, with unintended interruption of the power supply as a result.

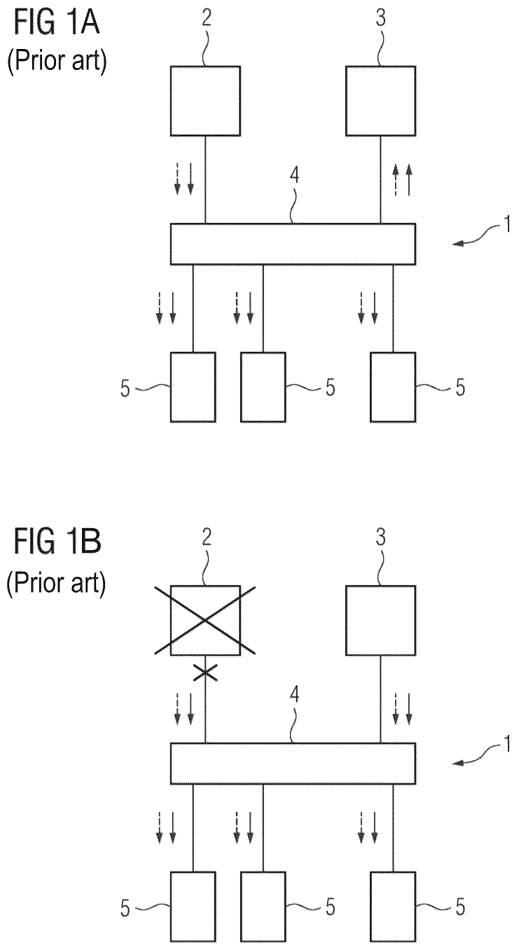

FIGS. 1a and 1b illustrate the time recording process according to PTP within a process bus communication network 1, wherein two timing units 2 and 3 are provided and transmit PTP synchronization messages, according to the predefined “Announce”, “Sync” and “Follow_Up” structure, via an Ethernet switch 4 to IEDs 5, for example protection devices, which are likewise connected to the process bus communication network 1. In FIGS. 1a and 1b, a dashed arrow corresponds to a PTP Announce message, and a solid arrow represents a Sync or Follow-up message. The IEDs 5 are in the slave state provided in the PTP protocol. They therefore have a passive behavior with regard to the recording of time values and adopt the time specified to them by a timing unit that is in the so-called grandmaster role.

The timing units 2, 3 may be connected to a primary reference clock source—the so-called Primary Reference Clock (PRC)—for example to the Global Navigation Satellite System (GNSS). However, on account of being able to be influenced by interfering transmitters (jamming) or other means (for example spoofing), such satellite-based global reference clock sources constitute a risk and often cannot be used depending on their field of use. In such a case, it is possible to use a device-internal oscillator that is installed in one of the timing units 2, 3, wherein these then specify a relative time reference in the form of time values in the process bus communication network 1 independently of the outside.

Relative time values which are provided by the local oscillator in the timing units 2, 3 suffice for synchronization when a process bus communication network 1 is used in a substation, since no absolute time values are required.

The use of two timing units is used for redundancy, that is to say availability purposes. Under failure-free conditions, a single timing unit 2 is selected to be the active grandmaster with the aid of a so-called best master clock algorithm. This unit transmits PTP synchronization messages via the Ethernet switch 4. The other timing unit 3 does not transmit any PTP synchronization messages and is in the slave state. It receives PTP synchronization messages from the grandmaster timing unit 2 and synchronizes its own internal oscillator according to the oscillator of the timing unit 2, with the result that the internal oscillator of the timing unit 3 oscillates virtually at the same speed as the internal oscillator of the timing unit 2. However, the timing unit 3 is ready to change to an active role.

FIG. 1b illustrates a situation in which the timing unit 2 has failed or has been disconnected from the network. The absence of the timing unit 2 is detected by the timing unit 3 on account of the absence of PTP Announce messages from the timing unit 2. The timing unit 3 changes to the grandmaster role.

The IEDs detect the change of the grandmaster from the timing unit 2 to the timing unit 3 on the basis of the PTP messages. The time synchronization of the IEDs is not disrupted since the internal oscillator of the timing unit 3 was synchronized with the oscillator of the timing unit 2 before the switchover. The synchronization of the time recording among the IEDs is continued smoothly. There is no jump in time during or after the grandmaster switchover.

If the malfunction of the timing unit 2 is over or the decoupled timing unit 2 has been connected to the process bus communication network 1 again, the BMCA according to the invention immediately decides that the timing unit 2 takes over the grandmaster role. As the grandmaster timing unit 2, it begins again to transmit PTP synchronization messages.

During the absence of the timing unit 2, the local oscillator of the timing unit 3 runs at its own speed and distances itself, in terms of time, from the local oscillator of the timing unit 2. The time and frequency difference between the local oscillators of the timing units 2 and 3 may be considerable at the time at which the timing unit 2, which is functional or connected again, takes over. After the takeover, the IEDs detect a jump in time and synchronize their internal oscillator again with the new local oscillator of the new grandmaster timing unit 2. This resynchronization process may take up to 20 seconds.

The IEDs disable their protection functions during this resynchronization in order to prevent possible false tripping of the circuit breakers. This is a considerable disadvantage.

FIG. 2 illustrates the facts described above with the aid of a two-dimensional graph, on the abscissa of which the time is illustrated and on the ordinate 6 of which the time offset of the timing unit 3 with respect to the timing unit 2 according to FIG. 1 is illustrated, in each case in arbitrary units. The distance 20 between the dashed lines is the degree of the time offset between the timing units 2 and 3 which is permitted for the protection applications of the IEDs. The solid curve therefore represents said time offset on the basis of the time. If the curve is between the dashed lines, it is an acceptable time offset.

In the time range referenced with 7, the timing unit 2 operates in a fault-free manner and is connected to the process bus communication network 1. It operates in this range 7 as the grandmaster timing unit 2. At the time 8, the grandmaster role is taken over by the timing unit 3 since PTP Announce messages from the timing unit 2 are absent and this is detected by the timing unit 3. In the time range 9, the timing unit 3 then operates as the grandmaster timing unit 3. At the time 10, the grandmaster role is switched back to the timing unit 2. Since the oscillators of the timing units 2 and 3 were no longer synchronized in the time range 9, the time values from the timing unit 3 have moved away from those from the timing unit 2. In the time range 11, this deviation is greater than allowed. The IEDs detect said jump in time and synchronize their internal oscillator again until, at the time 12, the IEDs are synchronized with the returning grandmaster timing unit 2. The previous method has the disadvantage that the protection algorithms of the IEDs are disabled in the dashed time range 11.

The object of the invention is to specify a method of the type mentioned at the outset, in which disabling of the protection algorithms of the IEDs can be reduced in terms of time or even completely avoided.

This object is achieved according to the invention by the features of patent claim 1.

The dependent patent claims relate to variants of this invention.

Within the scope of the invention, it was recognized that the disadvantage of the prior art just described is caused by the fact that a PTP timing unit with grandmaster capability takes over the grandmaster role as soon as it has determined that it is the best PTP timing unit in the network according to the BMCA (Best Master Clock Algorithm). A timing unit with grandmaster capability according to the PTP is a timing unit which can take over the grandmaster role on the basis of the BMCA and can simultaneously become the sole synchronization source, the grandmaster, in a network. The problem recognized by the inventors of mutually unsynchronized local oscillators when switching back the grandmaster role is not taken into account in the BMCA and the PTP port state machine. This results in the described jump in time and in the protection functions (protection algorithms) being disabled.

The present invention proposes that a locally synchronized timing unit with grandmaster capability which has been restored or connected again does not immediately assume the grandmaster role, but rather the following steps are run through first:

A check is first of all carried out in order to determine whether there is currently an active PTP grandmaster of the dedicated PTP domain which is defined by its domain number. This check is carried out by waiting for the receipt of a PTP Announce message. If the timing unit with grandmaster capability does not receive a PTP Announce message from another timing unit within a previously defined time frame, it is assumed that there is no active grandmaster in the domain. If no other grandmaster is detected in the network, the BMCA is executed by the timing unit. It changes to the grandmaster role.

However, if a grandmaster timing unit is detected in the network, the timing unit changes to its slave state and begins to synchronize its own internal oscillator with that of the current grandmaster.

After the timing unit has synchronized its own internal oscillator with the grandmaster with the required accuracy, the enforcement of its slave state is canceled. The BMCA is executed and, depending on the result of this check, said timing unit will change to the grandmaster role or will remain in the slave state.

The decisive point is therefore that the timing unit with grandmaster capability that has been restored or connected again initially synchronizes its own internal oscillator with that of the current PTP grandmaster timing unit if available, before it takes over the grandmaster role. This avoids a jump in time.

For the purposes of the invention, a locally restricted network, which is referred to as a “local area network” and as a “LAN” for short, should be understood as meaning a spatially restricted network. For example, the locally restricted network is a network defined in IEC standard IEC 61850. Advantageously, the locally restricted network has structured cabling. According to a preferred variant, the network is a process bus communication network. The spatially restricted network comprises intelligent electrical devices (IEDs) that are connected to one another for example by wired communication lines or radio, e.g. 5G radio networks. However, the use of Ethernet technology is preferred within the scope of the invention. In principle, however, other locally restricted networks are also possible within the scope of the invention.

The abbreviation IED should be understood within the scope of the invention as meaning an intelligent electronic device. The IED is, for example, a protection or automation device, a relay or a field control device that is used for example in the field of protection and control engineering in substations. An IED is often also referred to as a processor-based controller.

The PTP is advantageously used within the scope of the invention, wherein the slave state is forced by setting the priority of said timing unit. If the priority of a timing unit with grandmaster capability is set to 254 or 255, for example, it will remain in its slave state during a check by the BMCA.

The check as to which timing unit is better suited to the active grandmaster role is advantageously carried out according to the best master clock algorithm of the IEEE 1588 protocol.

Further advantages arise if each timing unit has its own oscillator. Such an oscillator has, for example, a quartz crystal, the oscillations of which are converted into a time standard. However, oscillators are known to a person skilled in the art, and so their exact method of operation does not need to be discussed any further at this point. However, within the scope of the invention, the oscillator used in a timing unit can be synchronized with another oscillator.

According to a further expedient variant, the locally restricted network is a radio network. In particular, advantages arise if the radio network is a 5G radio network.

According to one preferred configuration of the invention, the locally restricted network is a process bus communication network of a substation. Ethernet technology is preferably used in the process bus communication network.

Within the scope of the invention, the number of timing units is not restricted to two timing units. For example, five or more timing units may also communicate with one another in the network.

At least one timing unit is expediently integrated, or in other words installed, in an IED. It is therefore a component part of the IED and is arranged in its housing.

Further advantages arise if at least one IED is a protection or automation device of an electrical power supply network.

A further variant of the method according to the invention involves the timing unit with grandmaster capability which is available again or is connected to the network again not immediately taking over the grandmaster role again after it has synchronized with the current grandmaster. Instead, it remains in the slave state and continues to continuously synchronize with the current grandmaster timing unit. Only when the absence of a grandmaster timing unit is detected does said timing unit change to the grandmaster role on the basis of the BMCA. This reduces the number of grandmaster switchovers in the network. This is advantageous with regard to the stability of PTP synchronization.

The present invention also relates to a timing unit for a locally restricted network, via which intelligent electronic units (IEDs) are connected to one another. According to the invention, at least this timing unit is configured to carry out one of the methods mentioned above.

For the purposes of the invention, a timing unit can be understood as meaning any unit that is able to generate a time standard. This unit may be present as a separate device or may be a component or component part of another device, for example a protection or automation device.

The invention is explained in more detail below using exemplary embodiments, in which case identical reference signs refer to identically acting components and

FIG. 1a schematically illustrates an exemplary embodi ment of a process bus communication network having two functional timing units,

FIG. 1b schematically illustrates an exemplary embodi ment of a process bus communication network having a timing unit which has failed or has been disconnected from the network,

FIG. 2 schematically illustrates a two-dimensional graph for illustrating a method for taking over the grandmaster role according to the prior art,

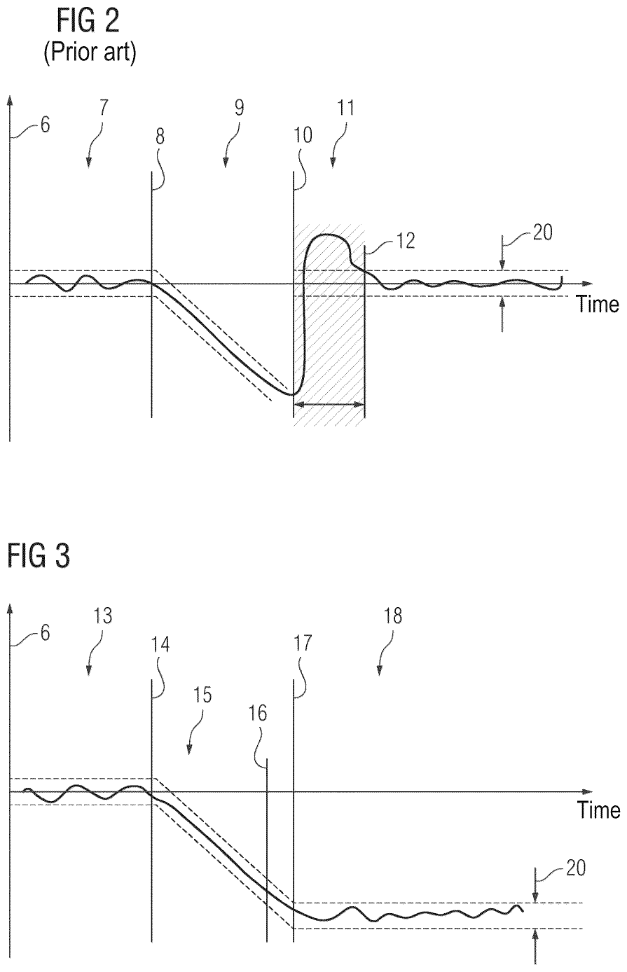

FIG. 3 schematically illustrates a two-dimensional graph for illustrating a method for taking over the grandmaster role according to the invention, and

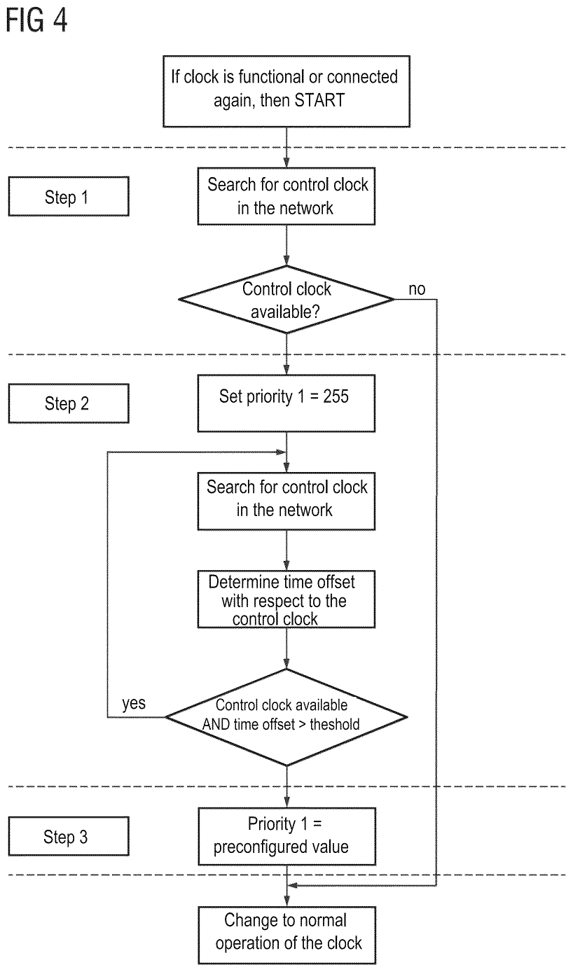

FIG. 4 schematically illustrates an exemplary embodi ment of the method according to the invention on the basis of a flowchart.

FIGS. 1a, 1b and 2 were already discussed in connection with the acknowledgement of the prior art.

FIG. 3 illustrates an exemplary embodiment of the method according to the invention. It schematically shows the progression of the timing, which is specified in a local area network according to FIG. 1 and to which the IEDs in the network 1 synchronize, on the basis of a two-dimensional graph, on the abscissa of which the time is illustrated and on the ordinate 6 of which the time offset of the timing unit 3 with respect to the timing unit 2 according to FIG. 1 is illustrated, in each case in arbitrary units.

The distance 20 between the dashed lines is again the degree of the time offset between the timing units 2 and 3 which is permitted by the protection applications of the IEDs. The solid curve therefore represents the progression of the time offset between the timing units on the basis of the time. If the curve is between the dashed lines, it is an acceptable time offset.

In the time range referenced with 13, the timing unit 2 operates in a fault-free manner and is connected to the process bus communication network 1. It operates as the grandmaster timing unit 2 in this range 13. At the time 14, the grandmaster role is taken over by the timing unit 3. In the time range 15, the timing unit 3 then operates as the grandmaster timing unit 3. At the time 16, the timing unit 2 has regained its full functionality. In another exemplary embodiment, it was disconnected from the network and has connected to the network 1 again at the time 16.

In contrast to the prior art, it does not immediately take over the grandmaster role again, but rather synchronizes, or in other words synchronizes its oscillator with that of the grandmaster timing unit 3. This synchronization is achieved at the time 17. The BMCA is used to determine that the timing unit 2 is better suited to the grandmaster role. There is a switchover of the grandmaster role at the time 17. In the time range 18, the timing unit 2 performs the grandmaster role again.

Within the scope of the invention, the permitted limits with respect to the time offset of the IEDs are not exceeded at any time. Disabling of the protection algorithms of the IEDs is avoided within the scope of the invention.

In order to avoid the immediate takeover of the grandmaster role within the scope of the invention, that is to say in other words to force the slave state of the respective timing unit, work is carried out with so-called priorities within the scope of this exemplary embodiment of the invention that is based on PTP. However, it should be pointed out that the slave state can also be forced using other means, without departing from the scope of the invention.

Priorities are parameters which are defined in the IEEE 1588 standard and are evaluated by the BMCA. Accordingly, the priority 1 and the priority 2 can in principle be assigned to each timing unit 2. After failure of the timing unit 2, its priority 1 is limited to 255 and 254. The value for the priority of the timing unit 3 remains completely configurable by the user. The priority 2 therefore remains at the value previously preset by the user of the network.

Under normal, disturbance-free conditions, the priority parameter configured by the user is used. At the time 16, the priority 1 value of the timing unit 2 is set to the highest possible value 255; this corresponds to the lowest priority for taking over the grandmaster role. During execution of the BMCA, the timing unit 2 therefore remains reliably in its slave state.

At the time 17, the internal oscillator of the timing unit 2 is synchronized with the current PTP grandmaster, specifically the oscillator of the timing unit 3, with the required accuracy. At the time 17, the priority 1 value of the timing unit 2 is reset to its value previously set by the user. The enforcement of the sleep state is therefore canceled. The timing unit 2 takes over the grandmaster role again by executing the BMCA.

FIG. 4 illustrates the method according to the invention by means of a flowchart. For reasons of space, instead of a timing unit in the grandmaster role, reference is made in FIG. 4 to a control clock.

If a timing unit—for example the timing unit 2—becomes functional again or is connected to the network again, a first step determines whether the network contains a timing unit in the grandmaster role, that is to say a control clock. If there is no control clock, the timing unit 2 changes to its normal operation. A BMCA will determine that the timing unit 2 shall take over the grandmaster role. This is then implemented.

However, if it is determined that the network contains a control clock, the priority 1 of the timing unit 2 is set to 255. This forces the timing unit 2 into the slave state. The control clock is then searched for in a loop and the timing unit 2 synchronizes with the control clock, that is to say with the timing unit 3 here. This loop is run through until the time offset between the control clock and the timing unit 2 is greater than the predefined limit value and the control clock is still available. The priority 1 value is then set to its preconfigured value again.

1-10. (canceled)

11. A method for synchronizing intelligent electronic units IEDs in a locally restricted network, wherein the locally restricted network has at least two timing units, the method comprising:
for a first timing unit which has become functional again or has been reconnected to the network, checking to determine whether the network contains a further timing unit which assumes an active grandmaster role;
when a further timing unit in the grandmaster role was detected in the locally restricted network, forcing the first timing unit into a slave state, and synchronizing the first timing unit with the further timing unit in the grandmaster role;
after the synchronizing, canceling an enforcement of the slave state for the first timing unit;
when the first timing unit is better suited to the grandmaster role, changing the first timing unit to the role of the grandmaster timing unit, or retaining the first timing unit in the slave state when another timing unit in the network is better suited to the grandmaster role.

12. The method according to claim 11, which comprises using a precision time protocol (PTP) for forcing the first timing unit into the slave state by setting a priority of the timing unit.

13. The method according to claim 11, which comprises checking which of the timing units is better suited to the active grandmaster role by the best master clock algorithm of the IEEE 1588 protocol.

14. The method according to claim 13, wherein each timing unit in the network has an oscillator.

15. The method according to claim 11, wherein the locally restricted network is a domain.

16. The method according to claim 11, wherein the locally restricted network is a process bus communication network of a substation.

17. The method according to claim 11, wherein at least one IED is a protection or automation device.

18. The method according to claim 11, wherein at least one timing unit is installed in an IED.

19. The method according to claim 11, which comprises retaining a timing unit with grandmaster capability that has become available again or has been reconnected to the network in the slave state and synchronizing continuously with a current grandmaster timing unit and changing to the grandmaster role only when the grandmaster timing unit is removed.

20. A timing unit for a locally restricted network, via which intelligent electronic units IEDs are connected to one another, the timing unit being configured to carry out the method according to claim 11.
